(19) United States
(12) Patent Application Publication
(10) Pub. No.: US 2006/0008254 A1
(43) Pub. Date: Jan. 12, 2006

(54) Method of synchronizing still picture with moving picture stream

(75) Inventor: Kwang Deok Seo, Wonju-si (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/176,618

(22) Filed: Jul. 6, 2005

(30) Foreign Application Priority Data
Jul. 7, 2004 (KR) 10-2004-0052619

(51) Int. Cl. H04N 5/76; H04N 5/225

(52) U.S. Cl. 386/120; 386/121

(57) ABSTRACT

A method of synchronizing a still picture with a moving picture stream is disclosed, which is suitable for supporting a multimedia service further using a still picture to provide separate video data as well as moving pictures and voice. The present invention includes the steps of generating a control data for synchronization of the still picture from a server, providing the control data to a client through a prescribed moving picture frame of the moving picture stream by the server, and synchronizing the still picture with the moving picture stream to display by the client.

This application claims the benefit of the Korean Patent Application No. P10-2004-0052619, filed on Jul. 7, 2004, which is hereby incorporated by reference as if fully set forth herein.

### BACKGROUND OF THE INVENTION

1. Field of the Invention

The present invention relates to a method of synchronizing a still picture with a moving picture stream. Although the present invention is suitable for a wide scope of applications, it is particularly suitable for supporting a multimedia service further using a still picture to provide separate video data as well as moving pictures and voice.

2. Discussion of the Related Art

Generally, various systems according to the related art offering multimedia services through real-time transmission of moving pictures and voices have been introduced. For instance, there are a remote video conference system, a remote video education system and the like.

The multimedia service offering systems use the moving pictures coding standard specifications such as H.261, H.263 and MPEG.

So, each pf the related art multimedia offering systems combines a moving picture signal and a voice signal together to transmit to a remote client (user terminal) on real time.

Yet, in the process of a remove video conference or a remote video education, conference materials, education materials and the like need to be separately provided. Generally, it is preferable that the conference materials, education materials and the like are provided as a still picture (e.g., JPEG).

However, the related art systems provide the multimedia services using moving pictures and voices only, thereby being unsuitable for providing separate video data such as the conference materials, the education materials and the like.

### SUMMARY OF THE INVENTION

Accordingly, the present invention is directed to a method of synchronizing a still picture with a moving picture stream that substantially obviates one or more problems due to limitations and disadvantages of the related art.

An object of the present invention is to provide a method of synchronizing a still picture with a moving picture stream, which is suitable for supporting a multimedia service further using a still picture to provide separate video data as well as moving pictures and voice.

Another object of the present invention is to provide a method of synchronizing a still picture with a moving picture stream, which is suitable for additionally support the still picture for providing separate video data to basic moving pictures of a multimedia service offered by such a system as a remote video conference system and a remote video education system and by which the still picture can be outputted while moving pictures are streaming.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in a system supporting a multimedia service, a method of synchronizing a still picture with a moving picture stream according to the present invention includes the steps of generating a control data for synchronization of the still picture from a server, providing the control data to a client through a prescribed moving picture frame of the moving picture stream by the server, and synchronizing the still picture with the moving picture stream to display by the client.

Preferably, the method further includes a step of previously providing a code to the client by the server, wherein the code is to indicate that the control data shall be provided.

Preferably, the method further includes the steps of allowing the client to previously receive a code indicating that the control data shall be provided and allowing the client to receive the moving picture frame containing the control data.

In another aspect of the present invention, in a server providing a multimedia service to a client, a method of synchronizing a still picture with a moving picture stream includes the steps of inserting an identifier of the still picture frame to be synchronized with the moving picture stream in a prescribed moving picture frame of the moving picture stream and transmitting the prescribed moving picture frame including the identifier to the client.

Preferably, the method further includes a step of inserting a code prior to the identifier wherein the code is to indicate that the identifier is included in the moving picture frame.

In another aspect of the present invention, in a client provided with a multimedia service by a server, a method of synchronizing a still picture with a moving picture stream includes the steps of extracting a moving picture frame including a identifier of the still picture from the moving picture stream, reading the identifier from the moving picture frame, and synchronizing the still picture with the moving picture stream to display using the identifier.

Preferably, the method of claim further includes a step of receiving a code indicating that the moving picture frame including the identifier shall be received.

In a further aspect of the present invention, in a system including a server supporting a multimedia service and a client, a method of synchronizing a picture frame with a picture stream includes the steps of allowing each of the server and the client to store the picture frame, generating control data for synchronization of the picture frame from the server, allowing the server to provide the control data to the client via a prescribed frame of the picture stream, and allowing the client to display the stored picture frame at a synchronization timing point by the control data.

Preferably, the method further includes a step of allowing the server to previously provide the client with a code indicating the prescribed frame to provide the control data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of a syntax structure of a moving picture frame of a video coding standard specification according to one embodiment of the present invention;

FIG. 2 is a diagram of a configuration of a transmitting terminal according to one preferred embodiment of the present invention;

FIG. 3 is a flowchart of a procedure of a transmitting terminal to synchronize a still picture with moving pictures according to one preferred embodiment of the present invention;

FIG. 4 is a diagram of a configuration of a receiving terminal according to one preferred embodiment of the present invention; and

FIG. 5 is a flowchart of a procedure of a receiving terminal to synchronize a still picture with moving pictures according to one preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

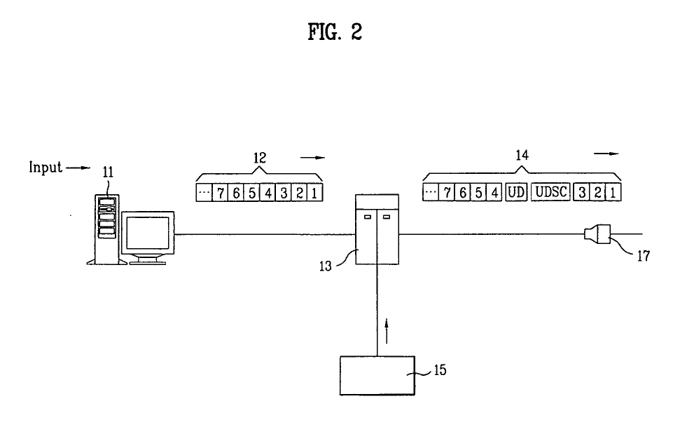

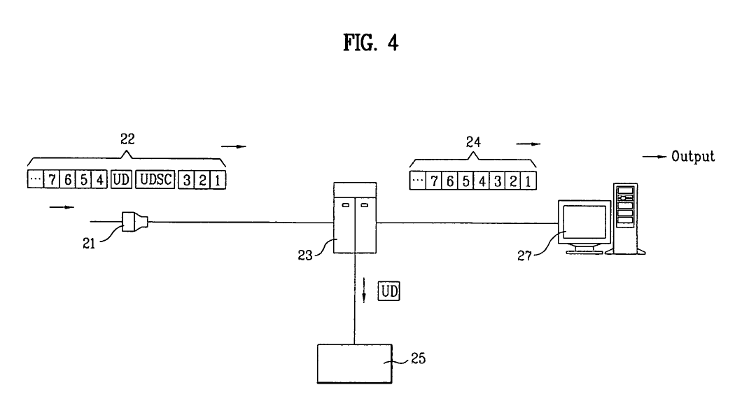

First of all, a system according to the present invention includes a transmitting terminal shown in FIG. 2 and a receiving terminal shown in FIG. 4. And, the system according to the present invention supports a multimedia service via a network.

The system according to the present invention employs a server-client configuration. The server is the transmitting terminal providing the multimedia service and the client (user terminal) is the receiving terminal provided with the multimedia service.

In the present invention, the transmitting terminal provides prescribed multimedia to the receiving terminal. In particular, the multimedia is streamed to the receiving terminal from the transmitting terminal in aspect that the multimedia are transmitted on real time.

The multimedia is a moving picture combined with a voice. Meanwhile, the moving picture, as stated in the following, will be dealt inclusively with the same concept of video or video data.

The system according to the present invention further provides a still picture in the process of streaming the moving picture, i.e., in the process of transmitting a moving picture stream, simultaneously. For this, the system according to the present invention synchronizes a frame corresponding to the corresponding still picture with the moving picture stream.

For instance, the system according to the present invention provides such a multimedia service as a remote video conference service and a remote video education service.

Through the aforesaid services, a conference or education scene is provided as a moving picture stream. And, in case that separate conference data, education data and the like need to be provided as a still picture while the moving picture stream is being provided, a corresponding still picture frame is synchronized with a current moving picture stream.

Hence, the receiving terminal synchronizes the still picture frame, which corresponds to conference data, education data or the like, with the moving picture stream in the process of continuously displaying the moving picture stream and then displays the still picture corresponding to the conference or education data at a time point according to the synchronization. In this case, the still picture is motionless image data.

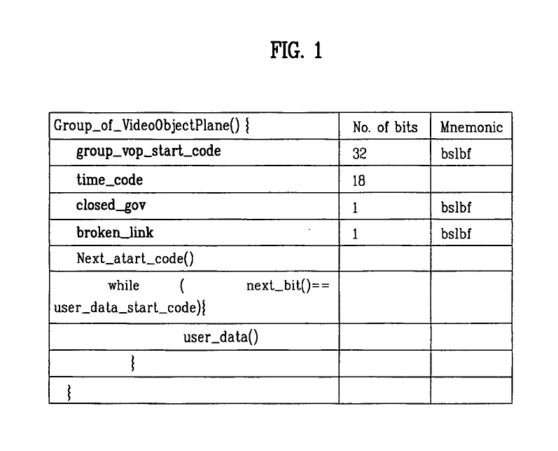

Meanwhile, the moving picture stream includes a plurality of moving picture frames. And, the moving picture frame in the moving picture stream has a User_Data field as a user data area. A syntax of the User_Data field is shown in FIG. 1.

FIG. 1 is a diagram of a syntax structure of a moving picture frame of a video coding standard specification according to one embodiment of the present invention, in which a syntax of MPEG-4 User_Data field is shown.

Preferably, the moving picture of the present invention belongs to the MPEG (moving picture experts group) series as the video coding standard specification. For instance, the MPEG series includes MPEG-1, MPEG-2, MPEG-3, MPEG-4 and the like.

And, it is preferable that the still picture corresponding to the conference or education data in the present invention belongs to the JPEG (joint photographic expert group) series. Yet, the present invention does not put limitation on the above standard specifications for the moving or still picture.

A configuration and operation of a system according to one preferred embodiment of the present invention are explained in detail as follows.

FIG. 2 is a diagram of a configuration of a transmitting terminal according to one preferred embodiment of the present invention.

Referring to FIG. 2, a transmitting terminal includes an encoder 11, a multiplexer 13, a control data generator, and a UDP (user datagram protocol) socket 17. And, the transmitting terminal further includes a memory (not shown in the drawing) storing conference data, education data and the like coded into a still picture.

In the present invention, the transmitting terminal stores the still picture of the conference data, education data and the like.

Besides, a receiving terminal shown in FIG. 4 stores the same still picture as well. Hence, the receiving terminal does not receive the still picture from the transmitting terminal actually but receives control data for synchronization of the still picture only.

In particular, the receiving terminal synchronizes the corresponding still picture with a moving picture using the received control data, which will be explained in detail later.

The still picture stored in the memory of the transmitting terminal has a frame structure. And, a unique identifier is given to each still picture. In this case, it is preferable that the identifier is a frame number uniquely given to a still picture frame.

The encoder 11 encodes an inputted moving picture and then outputs a moving picture stream 12 constructed with a plurality of moving picture frames.

In case of intending not to provide any kind of still pictures stored in the memory from the transmitting terminal, the multiplexer 13 bypasses the moving picture stream 12 outputted from the encoder 11.

In contrast, in case of intending to further provide a specific still picture corresponding to the conference or education data to a client from the transmitting terminal, the multiplexer 13 multiplexes control data for synchronization of the specific still picture with the moving picture stream 12 outputted from the encoder 11.

The control data generator 15 generates the control data. Namely, each time a provision of prescribed conference or education data is requested, the control data generator 15 generates control data for synchronization of a corresponding still picture. The control data generator 15 then outputs the generated control data to the multiplexer 13.

And, the corresponding multiplexing is executed in the following manner.

First of all, the control data is inserted in a prescribed moving picture frame of the moving picture frame.

Secondly, the control data is inserted in a User_Data filed (cf. FIG. 1) of the prescribed moving picture frame of the moving picture frame 12.

Thirdly, one moving picture frame including the control data is configured to be inserted in the moving picture stream 12. In doing so, the moving picture frame including the control data is configured by the control data generator 15.

Meanwhile, the control data is an identifier uniquely given to identify the still picture corresponding to the prescribed conference or education data from other still pictures. Preferably, the control data is a unique frame identifier to identify a frame of the corresponding still picture from frames of other still pictures and includes one frame number.

Moreover, the transmitting terminal according to the present invention provides a code, which indicates that the control data is provided to inform the receiving terminal of a fact that the control data is provided, to the receiving terminal. Specifically, the transmitting terminal generates the code to provide to the receiving terminal each time the control data is generated. And, the code is provided to the receiving terminal prior to the moving picture frame in which the control data is inserted.

For instance, the transmitting terminal provides the code previously indicating the provision of the control data via a prescribed moving picture frame prior to the frame in which the control data is inserted. And, the code is a USER_DATA_START code (UDSC).

A steam 14 outputted from the multiplexer 13 is configured by inserting the frame, in which the control data for the synchronization of the still picture is inserted, and the USER_DATA_START code (UDSC) in the moving picture stream 12 outputted from the encoder 11.

And, the UDP socket 17 transmits the stream 14 outputted from the multiplexer 13 to the receiving terminal.

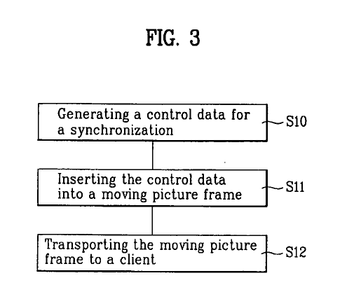

FIG. 3 is a flowchart of a procedure executed by a transmitting terminal to synchronize a still picture with moving pictures according to one preferred embodiment of the present invention.

Referring to FIG. 3, a transmitting terminal, which is a server of a multimedia service, generates control data for synchronization of a still picture corresponding to separate data (conference data, education data, etc.) of the multimedia service (S10).

The still picture is stored as a frame format in a memory and a corresponding still picture frame has a unique frame identifier. And, the frame identifier is to identify the corresponding still picture frame from other still picture frames stored in the memory.

The control data is the frame identifier of the corresponding still picture. And, the control data is the data generated using the frame identifier of the corresponding still picture.

The transmitting terminal inserts the generated control data in one moving picture frame (S11).

The moving picture frame, in which the control data is inserted, is either one moving picture frame belonging to a moving picture stream of the multimedia service or a prescribed frame configured separate from the moving picture stream.

In particular, the moving picture frame, in which the control data is inserted, has a User_Data field as shown in FIG. 1. And, the control data for synchronization is included in a user_data( ) function shown in FIG. 1.

Hence, the transmitting terminal transmits the moving picture frame having the control data inserted therein to a receiving terminal, which is a client, together with the moving picture stream according to the multimedia service (S12).

Meanwhile, the transmitting terminal previously provides a code for indicating that the control data will be provided to the receiving data before the control data is provided to the receiving terminal. In this case, the code is called a USER_DATA_START code (UDSC).

A timing point that the code is provided to the receiving terminal is prior to the moving picture frame in which the control data is inserted. In particular, the code is provided via a frame directly followed by the moving picture frame in which the control data is inserted. Specifically, the code is inserted in a head of the corresponding frame.

The frame used in providing the code is one moving picture frame belonging to the moving picture stream of the currently provided multimedia service or a prescribed frame configured separate from the moving picture stream.

In brief, in the present invention, each of the transmitting and receiving terminals previously stores the picture frame corresponding to the separate data (conference data, education data, etc.) of the multimedia service.

And, in case that a prescribed picture frame needs to be displayed together with a currently played moving picture frame, the transmitting terminal preferentially generates the control data required for the synchronization so that the corresponding picture frame stored in the receiving terminal can be synchronized with the moving picture frame to be displayed. In this case, the control data is a frame identifier for identifying the corresponding picture frame or data generated using the frame identifier.

To previously inform the provision of the control data, the transmitting data provides the code indicating the frame in which the control data is inserted to the receiving terminal and then provides the receiving terminal with the frame in which the generated control data is inserted.

FIG. 4 is a diagram of a configuration of a receiving terminal according to one preferred embodiment of the present invention.

Referring to FIG. 4, a receiving terminal includes a UDP socket 21, a demultiplexer 23, a browser 25, and a decoder 27. And, the receiving terminal further includes a memory (not shown in the drawing) coding conference data, education data and the like into still pictures to store therein. So, the receiving terminal receives control data for synchronization of the corresponding still picture from the transmitting terminal only and outputs the corresponding still picture at a synchronization timing point by the control data together with a moving picture, which will be explained in detail later.

The still picture stored in the memory of the receiving terminal has a frame structure. And, a unique identifier is given to each of the still pictures. In this case, it is preferable that the identifier is a frame number uniquely given to the corresponding still picture.

The UDP socket 21 receives a stream 22 transmitted from the transmitting terminal. The UDP socket 21 then outputs the received stream 22 to the demultiplexer 23.

The demultiplexer 23 outputs moving picture frames 24 of the received stream to the decoder 27.

The decoder 27 then decodes the inputted moving picture frames, whereby a video corresponding to the moving picture frames is outputted.

Besides, the demultiplexer 23 interoperating with the browser 25 to find a code inserted in the received stream. In this case, the code is to indicate the frame in which the control data is inserted. And, the code is a USER_DATA_START code (UDSC) to inform the receiving terminal of a fact that the control data will be provided.

Specifically, since the transmitting terminal transmits the code by inserting the code in the frame followed by the moving picture frame in which the control data is inserted, the demultiplexer 23 of the receiving terminal receives the code, reads the User_Data field of the frame indicated by the received code and then transmits the corresponding control data to the browser 25.

If so, the browser 25 searches the memory for the corresponding still picture frame of the identifier indicated by the control data. The browser 25 then synchronizes the searched still picture with a currently streamed moving picture to display together. In this case, the browser 25 is a JPEG browser.

Meanwhile, a timing point of synchronizing the still picture with the moving picture corresponds is the timing point corresponding to the frame in which the control data is inserted.

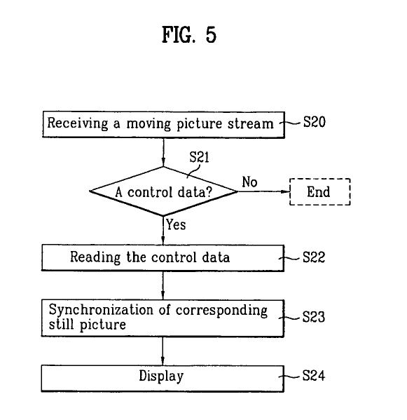

FIG. 5 is a flowchart of a procedure executed by a receiving terminal to synchronize a still picture with moving pictures according to one preferred embodiment of the present invention.

Referring to FIG. 5, a receiving terminal, which is a client of a multimedia service, receives a moving picture stream according to the multimedia service (S20).

The receiving terminal checks whether control data is included in the received moving picture stream (S21).

A process of checking whether the control data is included in the received moving picture stream is explained in detail as follows.

The receiving terminal searches for a code indicating a presence or non-presence of insertion of the control data for synchronization of a still picture. Namely, the receiving terminal searches for a USER_DATA_START code (UDSC). And, the receiving terminal searches for the control data by extracting a moving picture frame indicated by the USER_DATA_START code (UDSC).

The receiving terminal reads the control data from the moving picture frame indicated by the USER_DATA_START code (UDSC).

The receiving terminal searches for a corresponding still picture frame stored in a memory using an identifier indicated by the read control data and then synchronizes the searched still picture with the received moving picture stream (S23).

The receiving terminal then displays the still picture together with the moving picture at a timing point by the synchronization (S24).

In brief, the transmitting terminal transmits the moving picture of the remote video conference or the remote video education using the MPEG-series moving picture stream. While each of the transmitting and receiving terminals retains the encoded JPEG-series still picture corresponding to the same conference or education data, the receiving terminal receives the control data from the transmitting terminal and then searches for the still picture of the frame number indicated by the received control data via the browser. The receiving terminal then synchronizes the searched still picture with the currently streamed moving picture to display.

And, the system according to the present invention basically secures the synchronization between the moving picture and audio.

Accordingly, the present invention provides the following effects or advantages.

First of all, in case that the separate conference data needs to be further provided while the remote video conference system provides the remote video conference service, the present invention facilitates the corresponding conference data to be provided as the still picture to the client (user terminal). And, in case that the separate education data needs to be further provided while the remote video education system provides the remote video education service, the present invention facilitates the corresponding education data to be provided as the still picture to the client (user terminal).

Secondly, the present invention overcomes complexity or degradation of moving picture image quality in configuring the system offering a real-time multimedia service.

Finally, it is apparent to those skilled in the art that the present invention is applicable to various multimedia services implemented on wire/wireless network as well as on Internet.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. In a system supporting a multimedia service, a method of synchronizing a still picture with a moving picture stream, comprising the steps of;
generating a control data for synchronization of the still picture from a server;
providing the control data to a client through a prescribed moving picture frame of the moving picture stream by the server; and
synchronizing the still picture with the moving picture stream to display by the client.

2. The method of claim 1, wherein the moving picture frame has a User_Data area where the control data is inserted.

3. The method of claim 1, wherein the control data is a frame identifier to identify a frame of the still picture from frames of other still pictures.

4. The method of claim 1, wherein the moving picture is an MPEG (Moving Picture Experts Group) series.

5. The method of claim 1, wherein the still picture is a JPEG (Joint Photographic Expert Group) series.

6. The method of claim 1, further comprising a step of previously providing a code to the client by the server, wherein the code is to indicate that the control data shall be provided.

7. The method of claim 6, wherein the server provides the code prior to the moving picture frame.

8. The method of claim 6, wherein the server provides the code via a prescribed frame followed by the moving picture frame.

9. The method of claim 1, further comprising the steps of:
allowing the client to previously receive a code indicating that the control data shall be provided; and
allowing the client to receive the moving picture frame containing the control data.

10. The method of claim 9, wherein if the client finds the code from the moving picture stream, the client reads the control data included in the moving picture frame indicated by the code.

11. The method of claim 10, wherein the control data is an identifier to identify a frame of the still picture from a plurality of still pictures previously stored in the client.

12. The method of claim 1, wherein the client previously stores the still picture.

13. The method of claim 1, wherein the server previously stores the still picture.

14. The method of claim 13, wherein the server generates the control data using a frame identifier of the stored still picture.

15. In a server providing a multimedia service to a client, a method of synchronizing a still picture with a moving picture stream, comprising the steps of:
inserting an identifier of the still picture frame to be synchronized with the moving picture stream in a prescribed moving picture frame of the moving picture stream; and
transmitting the prescribed moving picture frame including the identifier to the client.

16. The method of claim 15, wherein the moving picture frame has a USER_DATA field where the identifier is inserted.

17. The method of claim 15, wherein the moving picture is an MPEG (Moving Picture Experts Group) series.

18. The method of claim 15, wherein the still picture is a JPEG (Joint Photographic Expert Group) series.

19. The method of claim 15, further comprising a step of inserting a code prior to the identifier wherein the code is to indicate that the identifier is included in the moving picture frame.

20. The method of claim 19, wherein the code is a USER_DATA_START code (UDSC).

21. The method of claim 19, wherein the code is inserted in a head of the moving picture frame.

22. The method of claim 19, wherein the code is inserted in a prescribed frame followed by the moving picture frame.

23. In a client provided with a multimedia service by a server, a method of synchronizing a still picture with a moving picture stream, comprising the steps of:
extracting a moving picture frame including a identifier of the still picture from the moving picture stream;
reading the identifier from the moving picture frame; and
synchronizing the still picture with the moving picture stream to display using the identifier.

24. The method of claim 23, wherein the moving picture is an MPEG (Moving Picture Experts Group) series.

25. The method of claim 23, wherein the still picture is a JPEG (Joint Photographic Expert Group) series.

26. The method of claim 23, further comprising a step of receiving a code indicating that the moving picture frame including the identifier shall be received.

27. The method of claim 23, wherein the identifier is read from a USER_DATA field of the moving picture frame.

28. In a system including a server supporting a multimedia service and a client, a method of synchronizing a picture frame with a picture stream, comprising the steps of:
allowing each of the server and the client to store the picture frame;
generating control data for synchronization of the picture frame from the server;
allowing the server to provide the control data to the client via a prescribed frame of the picture stream; and
allowing the client to display the stored picture frame at a synchronization timing point by the control data.

29. The method of claim 28, wherein the prescribed frame to provide the control data has a user data area in which the control data is inserted.

30. The method of claim 28, wherein the control data includes a frame identifier to identify the picture frame.

31. The method of claim 28, wherein the synchronization timing point is a timing point corresponding to the prescribed frame to provide the control data.

32. The method of claim 28, further comprising a step of allowing the server to previously provide the client with a code indicating the prescribed frame to provide the control data.
